(19) United States
(12) Patent Application Publication
(10) Pub. No.: US 2024/0400738 A1
(43) Pub. Date: Dec. 5, 2024

(54) POLYMER-CONTAINING COMPOSITIONS HAVING REDUCED HYDROPHOBIC LIQUID CONTENT AND METHODS

(71) Applicant: Sterling Specialty Chemicals Holding UK Limited, Harrow (GB)

(72) Inventors: Hong YANG, Norcross, GA (US); Pengpeng QI, Atlanta, GA (US)

(21) Appl. No.: 18/677,983

(22) Filed: May 30, 2024

Related U.S. Application Data
(60) Provisional application No. 63/505,369, filed on May 31, 2023.

(30) Foreign Application Priority Data
Sep. 21, 2023 (FI) 20236046

(51) Int. Cl. C08F 220/56; C08F 220/58; C08K 5/42; C09K 8/584; C09K 8/588

(52) U.S. Cl. CPC C08F 220/56; C08F 220/585; C08K 5/42; C09K 8/584; C09K 8/588; C09K 2208/00

(57) ABSTRACT

Methods of reducing an amount of hydrophobic liquid in a polymer-containing composition, such as a composition that includes a polymer, a surfactant, and water. Polymer-containing compositions having a reduced hydrophobic liquid content. Methods of polymer flooding.

### FIELD OF THE DISCLOSURE

This disclosure relates to polymer-containing compositions having a reduced hydrophobic liquid (e.g., oil) content, methods for removing or reducing an amount of hydrophobic liquid in compositions, and methods of polymer flooding.

### BACKGROUND

Liquid polymers are widely used in enhanced oil recovery reservoirs, particularly offshore reservoirs, due, at least in part, to their rapid dissolution. Dry hydrolyzed polyacrylamide (HPAM) enhanced oil recovery products typically require 24 to 48 hours for dissolution, but liquid emulsion polymers, including liquid emulsion sulfonated polymers, typically require less than four hours. Although liquid polymers have been used successfully in reservoirs having average permeabilities of 1,000 mD to 2,000 mD, there are a number of reservoirs having lower average permeabilities, e.g., 50 mD to 500 mD, that could benefit from the improved oil recovery imparted by liquid polymers.

There are one or more challenges associated with the use of emulsion polymers in low permeability reservoirs. For example, liquid polymers can reduce effective reservoir permeability, the pressure of polymer flooding may stabilize relatively late in polymer injection, the pressure of polymer flooding may stabilize at a relatively high resistance factor (RF) level, or a combination thereof.

One possible cause of one or more of these difficulties is the accumulation of oil from the oil phase of the emulsion, such as oil accumulation at the entrance of cores (see, e.g., Varadarajan, D. et al. “Permeability Reduction Due to Use of Liquid Polymers and Development of Remediation Options,” SPE Improved Oil Recovery Conference, Tulsa, OK, USA, April 2016). Surfactants have been used to reduce oil droplet sizes and/or improve liquid polymer injectivity into highly permeable sandstones and sandpacks (e.g., 2,000 mD to 5,000 mD).

Another possible cause includes the oscillations of trapped oil in a porous media due to polymer elasticity (see, e.g., Qi, P. “The Effect of Polymer Viscoelasticity on Residual Oil Saturation,” University of Texas at Austin, Dissertation, 2018). Trapped oil droplets may oscillate instead of flowing through pore throats when a Deborah number exceeds a certain threshold, such as 1. According to some tests, it may take time for all trapped oil droplets to oscillate at a steady frequency, and the oscillations can increase shear stress at local pore throats, thereby delaying pressure stabilization and/or causing the stabilized pressure to occur at a relatively high level.

There remains a needs for methods of improving liquid polymer injectivity capabilities, such as by providing early pressure stabilization, generating reasonable resistance factor levels, or a combination thereof, including for deposits having relatively low permeabilities. There also remains a need for methods of effectively reducing an amount of hydrophobic liquid (e.g., oil) in polymer compositions.

### BRIEF SUMMARY

Provided herein are methods that may include treating polymer-containing compositions with a sulfosuccinate ester salt to produce treated polymer-containing compositions having a reduced hydrophobic liquid (e.g., oil) content. The treated polymer-containing compositions may be injected into a deposit, such as a deposit featuring rock having a low permeability (e.g., about 50 mD to about 300 mD), and a differential pressure may stabilize relatively early, such as after the injecting of about 1.5 pore volumes of the liquid phase, and before the injecting of about 3.5 pore volumes.

In one aspect, methods of treating polymer-containing compositions are provided. The methods may include providing a composition, the composition comprising a polymer, a hydrophobic liquid, a surfactant, and water; and contacting the composition and a sulfosuccinate ester salt to form a mixture that includes a liquid phase and a solid phase. The hydrophobic liquid may be present in the composition at a first concentration, such as about 1 ppm to about 15,000 ppm, and the hydrophobic liquid may be present in the liquid phase at a second concentration, wherein the second concentration may be about 80% to 100% less than the first concentration. The hydrophobic liquid may have a boiling point of at least 100° C. The polymer may be a copolymer that includes an acrylamide monomer and a monomer that includes a sulfonic acid moiety or a sulfonate moiety.

In another aspect, methods of polymer flooding are provided. In some embodiments, the methods include providing a treated polymer-containing composition, such as a “liquid phase” produced by any of the methods provided herein; and injecting the treated polymer-containing composition (e.g., a “liquid phase”) into a mineral oil deposit. The mineral oil deposit may include rock having a permeability of about 50 mD (millidarcy) to about 2,000 mD.

In yet another aspect, treated polymer-containing compositions are provided. The treated polymer-containing compositions may have a reduced hydrophobic liquid content, and may include any of those prepared by the methods provided herein.

Additional aspects will be set forth in part in the description which follows, and in part will be obvious from the description, or may be learned by practice of the aspects described herein. The advantages described herein may be realized and attained by means of the elements and combinations particularly pointed out in the listing of embodiments and the appended claims. It is to be understood that both the foregoing general description and the following detailed description are exemplary and explanatory only and are not restrictive.

### BRIEF DESCRIPTION OF THE DRAWINGS

FIG. 1 depicts a plot of pressure versus pore volume for an embodiment of a treated polymer-containing composition.

FIG. 2 depicts a plot of resistance factor versus pore volume for an embodiment of a treated polymer-containing composition.

FIG. 3 depicts a plot of pressure versus pore volume for an embodiment of a treated polymer-containing composition.

FIG. 4 depicts a plot of resistance factor versus pore volume for an embodiment of a treated polymer-containing composition.

FIG. 5 depicts a plot of pressure versus pore volume for a comparative liquid.

### DETAILED DESCRIPTION

Provided herein are treated polymer-containing compositions having a reduced hydrophobic liquid content, methods of treating a polymer-containing composition, and methods of polymer flooding. The polymer-containing compositions that are treated by the methods described herein may include any of those known in the art, including, but not limited to, the inverted liquid polymer compositions described in WO 2017/100327 A1.

### Methods of Treating a Polymer-Containing Composition

In some embodiments, the methods of treating a polymer-containing composition include (i) providing a composition, the composition including a polymer, a hydrophobic liquid, a surfactant, and water, wherein the hydrophobic liquid is present in the composition at a first concentration; and (ii) contacting the composition and a sulfosuccinate ester salt to form a mixture, the mixture including a liquid phase and a solid phase, wherein the hydrophobic liquid is present in the liquid phase at a second concentration.

In some embodiments, the providing of the composition includes (i) providing an emulsion (e.g., a water-in-oil emulsion) that includes the polymer, the hydrophobic liquid, and the surfactant, wherein water is present in the emulsion at a concentration of less than 25 wt %, less than 15 wt %, less than 12 wt %, or less than 10 wt %, based on the weight of the emulsion; and (ii) contacting the emulsion and an additional amount of water to form the composition. The emulsion, prior to the contacting of the emulsion and the additional amount of water, may include at least about 20 wt %, about 25 wt %, about 30 wt %, about 35 wt %, about 39 wt %, about 40 wt %, about 45 wt %, about 50 wt %, about 55 wt %, about 60 wt %, about 65 wt %, about 70 wt %, or about 75 wt % of the polymer, based on the weight of the emulsion. The emulsion may include any of those described in WO 2017/100327 A1.

When the providing of the composition includes (i) providing an emulsion that includes the polymer, the hydrophobic liquid, and the surfactant, and (ii) contacting the emulsion and an additional amount of water to form the composition, the additional amount of water may include at least a portion of the sulfosuccinate ester salt. Therefore, the contacting of the emulsion and the additional amount of water may (i) provide the composition, and (ii) contact the composition and the sulfosuccinate ester salt at least partially simultaneously.

The liquid phase, before or after separation from the solid phase, may have a viscosity of at least 3 cP, or at least 3.5 cP, or about 3 cP to about 4 cP, or about 3.5 cP at 7 s⁻¹ at 25° C.

The contacting of the composition and the sulfosuccinate ester salt may be achieved using any known technique and/or apparatus. For example, the contacting may occur in a reactor, vessel, pipe, or other reservoir. The methods may include heating the mixture, applying one or more forces to the mixture, or a combination thereof. The heating and/or the one or more forces may be configured to facilitate separation of the liquid phase and the solid phase, and/or increase a rate of separation of the liquid phase and the solid phase. For example, the methods may also include heating the mixture to a temperature greater than ambient temperature, such as a temperature of at least 40° C., at least 50° C., at least 55° C., or at least 60° C. for any effective period of time, such as at least 1 minute, at least 30 minutes, at least one hour, or at least two hours. The methods also may include applying one or more forces to the mixture, wherein the one or more forces are effective to facilitate and/or increase a rate of separation of the liquid phase and the solid phase. The one or more forces may include any of those known in the art, such as a centrifugal force, a gravitational force, stirring, shaking, sonication, or a combination thereof.

The methods also may include separating the liquid phase and the solid phase. The separating of the liquid phase and the solid phase may be achieved using any known technique and/or apparatus, such as decanting, filtration, etc.

A hydrophobic liquid may be present in a composition at a first concentration prior to the contacting of the composition and sulfosuccinate ester salt. The first concentration may be any suitable concentration. In some embodiments, the first concentration is about 1 ppm to about 15,000 ppm, about 1 ppm to about 10,000 ppm, about 1 ppm to about 5,000 ppm, about 1 ppm to about 3,000 ppm, about 1 ppm to about 2,000 ppm, about 1 ppm to about 1,000 ppm, about 100 ppm to about 1,000 ppm, or about 500 ppm to about 1,000 ppm of the composition.

After the contacting of the composition and sulfosuccinate ester salt, the hydrophobic liquid may be present in the resulting liquid phase at a second concentration. The second concentration may be zero. The second concentration may be about 20% to 100%, about 40% to 100%, about 60% to 100%, about 80% to 100%, or about 90% to 100% less than the first concentration (e.g., if the first concentration is 10 units and the second concentration is 2 units, then the second concentration is 80% less than the first concentration).

### Sulfosuccinate Ester Salt

A polymer-containing composition may be contacted with any amount of a sulfosuccinate ester salt that is effective to achieve a desirable reduction in the amount of hydrophobic liquid that is present in the liquid phase described herein. After the contacting of a polymer-containing composition and a sulfosuccinate ester salt, the resulting mixture may include the sulfosuccinate ester salt at a concentration of about 0.01 wt % to about 10 wt %, about 0.01 wt % to about 8 wt %, about 0.01 wt % to about 6 wt %, about 1 wt % to about 5 wt %, or about 2 wt % to about 4 wt %, based on the weight of the composition (e.g., if 100 g of the composition and 1 g of the sulfosuccinate ester salt are present in the mixture, then the sulfosuccinate ester salt is present in the mixture at a concentration of 1 wt %, based on the weight of the composition).

The sulfosuccinate ester salt used in the methods herein may be any of those known in the art. In some embodiments, the sulfosuccinate ester salt is a sodium sulfosuccinate ester. The sulfosuccinate ester salt may be a sulfosuccinate monoester salt, a sulfosuccinate diester salt, or a combination thereof. In some embodiments, the sulfosuccinate ester salt is of formula (I)—

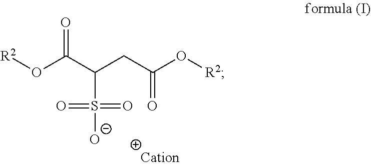

wherein R¹ and R² are independently selected from the group consisting of hydrogen and a C₁-C₃₀ hydrocarbyl. In some embodiments, the C₁-C₃₀ hydrocarbyl is a C₁-C₂₄ hydrocarbyl or a C₆-C₁₈ hydrocarbyl. The cation of formula (I) may be any known cation, such as a monovalent cation, a metal cation, or a monovalent metal cation (e.g., sodium). In some embodiments, R¹ is hydrogen, and R² is the C₁-C₃₀ hydrocarbyl, the C₁-C₂₄ hydrocarbyl, or the C₆-C₁₈ hydrocarbyl. In some embodiments, R¹ is the C₁-C₃₀ hydrocarbyl, the C₁-C₂₄ hydrocarbyl, or the C₆-C₁₈ hydrocarbyl, and R² is hydrogen. In some embodiments, R¹ and R² are independently selected from the group consisting of hydrogen, octyl, 2-ethylhexyl, hexyl, and cyclohexyl. In some embodiments, the sulfosuccinate ester salt is dioctyl sulfosuccinate sodium salt (e.g., bis(2-ethylhexyl) sulfosuccinate sodium salt).

### Polymer

The polymer may be present in the composition at any concentration, such as any concentration that is effective in various applications, such as enhanced oil recovery. For example, the polymer may be present in the composition at a concentration of about 50 ppm to about 15,000 ppm, about 50 ppm to about 10,000 ppm, about 50 ppm to about 5,000 ppm, about 50 ppm to about 3,000 ppm, about 50 ppm to about 2,000 ppm, about 50 ppm to about 1,000 ppm, about 100 ppm to about 1,000 ppm, or about 500 ppm to about 1,000 ppm.

The polymer, as described herein, may be a homopolymer or a copolymer. In some embodiments, the polymer is formed at least in part of an acrylamide monomer. In some embodiments, the polymer includes (i) an acrylamide monomer, and (ii) a monomer including a sulfonic acid moiety or a sulfonate moiety. The monomer including a sulfonic acid moiety or a sulfonate moiety may include any of those known in the art, such as acrylamide tertiary butyl sulfonic acid (ATBS), vinylsulfonic acid, allylsulfonic acid, 2-acrylamido-2-methylpropanesulfonic acid, 2-methacrylamido-2-methylpropanesulfonic acid, 2-acrylamidobutanesulfonic acid, 3-acrylamido-3-methylbutanesulfonic acid, or 2-acrylamido-2,4,4-trimethylpentanesulfonic acid.

When a polymer includes an acrylamide monomer, the acrylamide monomer may be present at any mol %. In some embodiments, the acrylamide monomer is present in the polymer at a mol % of about 50 to 100, about 60 to about 90, about 60 to about 80, about 70 to about 80, or about 75.

When a polymer includes a monomer that includes a sulfonic acid moiety or a sulfonate moiety, the monomer that includes a sulfonic acid moiety or a sulfonate moiety may be present in the polymer at a mol % of about 1 to about 50, about 10 to about 40, about 10 to about 30, about 20 to about 30, or about 25.

Additionally or alternatively, a polymer may include other monomers, including, but not limited to, acrylic acid, methacrylic acid, crotonic acid, itaconic acid, maleic acid, fumaric acid, monomers comprising phosphonic acid groups, vinylphosphonic acid, allylphosphonic acid, N-(meth)acrylamidoalkylphosphonic acids, (meth)acryloyloxyalkylphosphonic acids, hydroxyethyl(meth)acrylate, hydroxypropyl(meth)acrylate, allyl alcohol, hydroxyvinyl ethyl ether, hydroxyl vinyl propyl ether, hydroxyvinyl butyl ether or polyethyleneoxide(meth)acrylates, monomers having ammonium groups, 3-trimethylammonium propylacrylamides, 2-trimethylammonium ethyl(meth)acrylates, 3-trimethylammonium propylacrylamide chloride (DIMAPAQUAT), 2-trimethylammonium ethyl methacrylate chloride (MADAME-QUAT), monomers which may cause hydrophobic association of the (co)polymers, N-alkyl acrylamides, N-alkyl quaternary acrylamides, salts of the foregoing, or a combination thereof.

A polymer may be in any physical form when present in a composition or liquid phase, as described herein. In some embodiments, the polymer is in form of particles. The particles may be of any size, such as any size that does not undesirably impact an application, such as enhanced oil recovery. The particles of a polymer may have an average particle size of about 0.05 μm to about 30 μm, preferably from about 3 μm to about 18 μm; wherein the phrase “average particle size” refers to the d₅₀ value of the particle size distribution (number average).

A polymer may have any molecular weight that does not undesirably impact an application, such as enhanced oil recovery. In some embodiments, the polymer has a weight average molecular weight (M_{w}) of greater than about 5,000,000 Dalton, or greater than about 10,000,000 Dalton, or greater than about 15,000,000 Dalton, or greater than about 20,000,000 Dalton; or greater than about 25,000,000 Dalton.

### Hydrophobic Liquid

Any known hydrophobic liquid may be included in the compositions described herein. The hydrophobic liquid may be an organic hydrophobic liquid. The hydrophobic liquid may have a boiling point of at least 100° C., at least 135° C., or at least 180° C. (if the hydrophobic liquid has a boiling range, the phrase “boiling point” refers to the lower limit of the boiling range).

In some embodiments, the hydrophobic liquid includes an aliphatic hydrocarbon, an aromatic hydrocarbon (e.g., toluene, xylene, etc.), or a combination thereof. The hydrophobic liquid may include a paraffin hydrocarbon (e.g., saturated, linear, or branched), a naphthenic hydrocarbon, an olefin, an oil (e.g., a vegetable oil, such as soybean oil, rapeseed oil, canola oil, etc., and any other oil produced from the seed of any of several varieties of the rapeseed plant), a stabilizing surfactant, or a combination thereof.

### Surfactant

A surfactant generally may be present at any concentration in the compositions described herein. A surfactant may be present in a composition at a total concentration of about 1 ppm to about 1,000 ppm, about 1 ppm to about 800 ppm, about 1 ppm to about 700 ppm, about 1 ppm to about 600 ppm, about 1 ppm to about 500 ppm, about 1 ppm to about 400 ppm, about 1 ppm to about 300 ppm, or about 1 ppm to about 200 ppm. The phrase “total concentration”, with regard to surfactants, refers to the concentration of all surfactants that are present in a composition, e.g., if there are two different surfactants present in the composition, such as a first surfactant and a second surfactant, the “total concentration” is the sum of the concentration of the first surfactant and the concentration of the second surfactant.

The surfactant may include an emulsifier surfactant, an inverting surfactant, or a combination thereof. When a composition described herein is formed by inverting an emulsion, such as a water-in-oil emulsion, then the emulsifier surfactant and its concentration may be selected to (i) facilitate the formulation of, (ii) stabilize, and/or (iii) improve the stability of the emulsion. An inverting surfactant and its concentration may be selected to facilitate or increase the rate of inversion of the emulsion to form a composition described herein. When an inverting surfactant and an emulsifier surfactant are present in a composition, the inverting surfactant and the emulsifier surfactant may be different.

An emulsifying surfactant may lower the interfacial tension between water and a hydrophobic liquid, which may facilitate the formation of a water-in-oil polymer emulsion. It is known in the art to describe the capability of surfactants to stabilize water-in-oil-emulsions or oil-in-water emulsions by using the so called “HLB-value” (hydrophilic-lipophilic balance). The HLB-value usually is a number from 0 to 20. In surfactants having a low HLB-value, the lipophilic parts of the molecule predominate and consequently they are usually good water-in-oil emulsifiers. In surfactants having a high HLB-value, the hydrophilic parts of the molecule predominate and consequently they are usually good oil-in-water emulsifiers. In some embodiments, the emulsifying surfactant has an HLB-value of about 2 to about 10, or about 2 to about 8, and/or the inverting surfactant has an HLB-value of about 10 to about 20, about 10 to about 18, or about 12 to about 18.

In some embodiments, the emulsifier surfactant is selected from the group consisting of a sorbitan ester, an ethoxylated fatty alcohol with 1 to 4 ethyleneoxy groups, a phthalic ester, a fatty acid glyceride, a glycerine ester, a sorbitan monooleate, the reaction product of oleic acid and isopropanolamide, hexadecyl sodium phthalate, decyl sodium phthalate, sorbitan stearate, ricinoleic acid, hydrogenated ricinoleic acid, glyceride monoester of lauric acid, glyceride monoester of stearic acid, glycerol diester of oleic acid, glycerol triester of 12-hydroxystearic acid, glycerol triester of ricinoleic acid, an ethoxylated version of the foregoing comprising 1 to 10 moles of ethylene oxide per mole of the basic emulsifier, a modified polyester surfactant, an anhydride substituted ethylene copolymer, an N,N-dialkanol substituted fatty amide, a tallow amine ethoxylate, and a combination thereof.

In some embodiments, the inverting surfactant is selected from the group consisting of an ethoxylated alcohol, an alcohol ethoxylate, an ethoxylated ester of sorbitan, an ethoxylated ester of a fatty acid, an ethoxylated fatty acid ester, an ethoxylated ester of sorbitol and/or a fatty acid, a nonionic surfactant comprising a hydrocarbon group and a polyalkylenoxy group of sufficient hydrophilic nature, a nonionic surfactant of the general formula Rₐ—O—(CH(R_{b})—CH₂—O)ₙH, wherein Rₐ is a C₈-C₂₂-hydrocarbon group, n is a number of ≥4, and R_{b} is H, methyl or ethyl, and at least 50% of the groups R_{b} are H, a polyethoxylate based on a C₁₀-C₁₈-alcohol, a tridecylalcohol ethoxylate comprising 4 to 14 ethylenoxy groups, a modified polyester surfactant, an anhydride substituted ethylene copolymer, an N,N-dialkanol substituted fatty amide, a tallow amine ethoxylate, and a combination thereof.

### Water

The compositions described herein may include water from any source. For example, the water may include produced water, fresh water, salt water, or a combination thereof. The salt water may include sea water. The salt water may include a brine, such as a naturally-occurring brine. The brine may be a chloride-based, bromide-based, formate-based, or acetate-based brine comprising monovalent cations, polyvalent cations, or a combination thereof. When the compositions described herein are formed by inverting a water-in-oil emulsion, the compositions may include a first type of water that is present in the emulsion as the aqueous phase prior to inversion, and the composition may include a second type of water (e.g., process water) in which the emulsion is inverted. The first and second types of water may be different from each other. The water, such as the first and/or second type of water, may include about 15,000 mg/L to about 300,000 mg/L, about 15,000 mg/L to about 250,000 mg/L, about 15,000 mg/L to about 200,000 mg/L, about 15,000 mg/L to about 160,000 mg/L, about 15,000 mg/L to about 100,000 mg/L, about 15,000 mg/L to about 50,000 mg/L, about 30,000 mg/L to about 40,000 mg/L, or about 15,000 mg/L to about 16,000 mg/L total dissolved solids (tds).

Water may be present in a composition at any amount. For example, a composition may include water at an amount of at least 80 wt %, at least 85 wt %, at least 90 wt %, or at least 95 wt %.

### Methods of Polymer Flooding

Also provided herein are methods of polymer flooding. These methods may be used in a number of applications, such as enhanced oil recovery. In some embodiments, the methods include (i) providing a liquid phase as described herein; and (ii) injecting the liquid phase into a mineral oil deposit. The liquid phase may be injected at any effective rate, such as a rate of about 5 feet/day to about 20 feet/day, or about 10 feet/day to about 15 feet/day.

The mineral oil deposit may feature rock of any permeability. In some embodiments, the mineral oil deposit includes rock (e.g., sandstone) having a permeability of about 50 mD (millidarcy) to about 2,000 mD, about 50 mD to about 1,500 mD, about 50 mD to about 1,000 mD, about 50 mD to about 750 mD, about 50 mD to about 500 mD, or about 50 mD to about 300 mD. Therefore, the methods and liquid phases described may be effectively applied at low permeabilities, i.e., about 50 mD to about 500 mD, or about 50 mD to about 30 mD.

In some embodiments, a differential pressure—including at low permeabilities (e.g., about 50 mD to about 500 mD, or about 50 mD to about 300 mD)—stabilizes (i) after the injecting of about 1.5 pore volumes or about 2 pore volumes of the liquid phase, and (ii) before the injecting of about 3 pore volumes or about 3.5 pore volumes. A differential pressure “stabilizes” when the differential pressure reaches a value from which the differential pressure does not deviate by more than +/−20%, +/−15%, or +/−10% during the injection of at least 5, at least 6, at least 7, or at least 8 additional pore volumes of the liquid phase into the mineral oil deposit. In some embodiments, a resistance factor (RF) of the polymer flooding (i) after the injecting of about 1.5 pore volumes or about 2 pore volumes of the liquid phase, and (ii) before the injecting of about 3 pore volumes or about 3.5 pore volumes is within about 10% of (a) a theoretical resistance factor, or (b) a measured resistance factor of a comparative composition that does not include the hydrophobic liquid, and these limitations may be observed at low permeabilities (e.g., about 50 mD to about 500 mD, or about 50 mD to about 300 mD).

When used herein with regard to the selection of a substituent (for example, any of the various “R” groups), the term “independently” indicates that (i) a substituent at a particular location may be the same or different for each molecule a formula (e.g., (i) a compound of formula (I) may include two molecules of formula (I), with each molecule having the same or a different C₁-C₃₀ hydrocarbyl selected for R¹; or (ii) two differently labeled substituents selected from the same group of substituents may be the same or different (e.g., R¹ and R² of formula (I) may both be selected from “a C₁-C₃₀ hydrocarbyl”, and the C₁-C₃₀ hydrocarbyls selected for R¹ and R² may be the same or different).

The phrases “C₁-C₃₀ hydrocarbyl,” “C₁-C₁₈ hydrocarbyl”, and the like, as used herein, generally refer to aliphatic, aryl, or arylalkyl groups containing 1 to 30 carbon atoms, or 1 to 18 carbon atoms, respectively, including substituted derivatives thereof. Examples of aliphatic groups, in each instance, include, but are not limited to, an alkyl group, a cycloalkyl group, an alkenyl group, a cycloalkenyl group, an alkynyl group, an alkadienyl group, a cyclic group, and the like, and includes all substituted, unsubstituted, branched, and/or linear analogs or derivatives thereof, in each instance having, for example, 1 to 30 total carbon atoms or 1 to 18 total carbon atoms for a “C₁-C₃₀ hydrocarbyl” and “C₁-C₁₈ hydrocarbyl”, respectively. Examples of alkyl groups include, but are not limited to, methyl, ethyl, propyl, isopropyl, n-butyl, t-butyl, isobutyl, pentyl, hexyl, isohexyl, heptyl, 4,4-dimethylpentyl, octyl, 2,2,4-trimethylpentyl, nonyl, decyl, undecyl, and dodecyl. Cycloalkyl moieties may be monocyclic or multicyclic, and examples include cyclopropyl, cyclobutyl, cyclopentyl, cyclohexyl, and adamantyl, including any heteroatom substituted derivative thereof. Additional examples of alkyl moieties have linear, branched and/or cyclic portions (e.g., 1-ethyl-4-methyl-cyclohexyl). Representative alkenyl moieties include vinyl, allyl, 1-butenyl, 2-butenyl, isobutylenyl, 1-pentenyl, 2-pentenyl, 3-methyl-1-butenyl, 2-methyl-2-butenyl, 2,3-dimethyl-2-butenyl, 1-hexenyl, 2-hexenyl, 3-hexenyl, 1-heptenyl, 2-heptenyl, 3-heptenyl, 1-octenyl, 2-octenyl, 3-octenyl, 1-nonenyl, 2-nonenyl, 3-nonenyl, 1-decenyl, 2-decenyl, and 3-decenyl. Representative alkynyl moieties include acetylenyl, propynyl, 1-butynyl, 2-butynyl, 1-pentynyl, 2-pentynyl, 3-methyl-1-butynyl, 4-pentynyl, 1-hexynyl, 2-hexynyl, 5-hexynyl, 1-heptynyl, 2-heptynyl, 6-heptynyl, 1-octynyl, 2-octynyl, 7-octynyl, 1-nonynyl, 2-nonynyl, 8-nonynyl, 1-decynyl, 2-decynyl and 9-decynyl. Examples of aryl or arylalkyl moieties include, but are not limited to, anthracenyl, azulenyl, biphenyl, fluorenyl, indan, indenyl, naphthyl, phenanthrenyl, phenyl, 1,2,3,4-tetrahydro-naphthalene, anthracenyl, tolyl, xylyl, mesityl, benzyl, and the like, including any heteroatom substituted derivative thereof.

Unless otherwise indicated, the term “substituted,” when used to describe a chemical structure or moiety, refers to a derivative of that structure or moiety wherein (i) a multi-valent non-carbon atom (e.g., oxygen, nitrogen, sulfur, phosphorus, etc.) is bonded to one or more carbon atoms of the chemical structure or moiety (e.g., a “substituted” C₄ hydrocarbyl may include, but is not limited to, a pyrimidinyl moiety, a pyridinyl moiety, a dioxanyl moiety, a diethyl ether moiety, a methyl propionate moiety, an N,N-dimethylacetamide moiety, a butoxy moiety, etc., and a “substituted” aryl C₁₂ hydrocarbyl may include, but is not limited to, an oxydibenzene moiety, a benzophenone moiety, etc.) or (ii) one or more of its hydrogen atoms (e.g., chlorobenzene may be characterized generally as an aryl C₆ hydrocarbyl “substituted” with a chlorine atom) is substituted with a chemical moiety or functional group such as acyl, alcohol, alkoxy, alkanoyloxy, alkoxycarbonyl, alkenyl, alkyl (e.g., methyl, ethyl, propyl, t-butyl), alkynyl, alkylcarbonyloxy (—OC(O)alkyl), amide (—C(O)NH-alkyl- or -alkylNHC(O)alkyl), primary, secondary, and tertiary amino (such as alkylamino, arylamino, arylalkylamino), aryl, arylalkyl, aryloxy, azo, azido, carbamoyl (—NHC(O)O-alkyl- or —OC(O)NH-alkyl), carbamyl (e.g., CONH₂, as well as CONH-alkyl, CONH-aryl, and CONH-arylalkyl), carboxyl, carboxylic acid, cyano, cycloalkyl, cycloalkenyl, ester, ether (e.g., methoxy, ethoxy), halo, haloalkyl (e.g., —CCl₃, —CF₃, —C(CF₃)₃), haloalkoxy, trihalomethanesulfonyl, trihalomethanesulfonamido, heteroalkyl, heterocycloalkyl, heteroaryl, heteroarylalkyl, isocyanate, isothiocyanate, nitrile, nitro, oxo, phosphodiester, silyl, sulfide, sulfonamido (e.g., SO₂NH₂), sulfone, sulfenyl, sulfinyl, sulfonyl (including alkylsulfonyl, arylsulfonyl and arylalkylsulfonyl), sulfoxide, thiocarbonyl, thiocarbamyl, thiocyanato, thiol (e.g., sulfhydryl, thioether) or urea (—NHCONH-alkyl-).

As used herein, the phrase “enhanced oil recovery” (abbreviated “EOR”) refers to various techniques for increasing the amount of crude oil that can be extracted from an oil field that conventional techniques do not recover.

As used herein, “inverted” means that the liquid polymer emulsion is dispersed in an aqueous liquid, so that the dispersed polymer phase of the liquid polymer emulsion becomes a substantially continuous phase, and the hydrophobic liquid phase becomes a dispersed, discontinuous phase. The inversion point can be characterized as the point at which the viscosity of the inverted polymer solution has substantially reached its maximum under a given set of conditions. In practice, this may be determined for example by measuring viscosity of the composition periodically over time and when three consecutive measurements are within the standard of error for the measurement, then the solution is considered inverted.

As used herein, the terms “polymer,” “polymers,” “polymeric,” and similar terms are used in their ordinary sense as understood by one skilled in the art, and thus may be used herein to refer to a macromolecule molecule (or group of such molecules) formed of one or more recurring units (i.e., monomer). Polymers may be formed in various ways, including by polymerizing monomers and/or by chemically modifying one or more recurring units of a precursor polymer. A polymer may be a “homopolymer” comprising substantially identical recurring units formed by, e.g., polymerizing a particular monomer. A polymer may also be a “copolymer” comprising two or more different recurring units formed by, e.g., copolymerizing two or more different monomers, and/or by chemically modifying one or more recurring units of a precursor polymer. The term “terpolymer” may be used herein to refer to polymers containing three or more different recurring units. The term “polymer” as used herein is intended to include both the acid form of the polymer as well as its various salts.

As used herein, “polymer flooding” refers to an enhanced oil recovery technique using water viscosified with soluble polymers. Polymer flooding can yield a significant increase in oil recovery compared to conventional water flooding techniques. Viscosity is increased until the mobility of the injectant is less than that of the oil phase in place, so the mobility ratio is less than unity. This condition maximizes oil-recovery sweep efficiency, creating a smooth flood front without viscous fingering. Polymer flooding is also applied to heterogeneous reservoirs; the viscous injectant flows along high-permeability layers, decreasing the flow rates within them and enhancing sweep of zones with lower permeabilities. The two polymers that are used most frequently in polymer flooding are partially hydrolyzed polyacrylamide and xanthan. A typical polymer flood project involves mixing and injecting polymer over an extended period of time until at least about half of the reservoir pore volume has been injected.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of various embodiments, applicants in no way disclaim these technical aspects, and it is contemplated that the present disclosure may encompass one or more of the conventional technical aspects discussed herein.

The present disclosure may address one or more of the problems and deficiencies of known methods and processes. However, it is contemplated that various embodiments may prove useful in addressing other problems and deficiencies in a number of technical areas. Therefore, the present disclosure should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

In the descriptions provided herein, the terms “includes,” “is,” “containing,” “having,” and “comprises” are used in an open-ended fashion, and thus should be interpreted to mean “including, but not limited to.” When compositions or methods are claimed or described in terms of “comprising” various steps or components, the compositions or methods can also “consist essentially of” or “consist of” the various steps or components, unless stated otherwise.

The terms “a,” “an,” and “the” are intended to include plural alternatives, e.g., at least one. For instance, the disclosure of “a hydrophobic liquid”, “a polymer”, and the like, is meant to encompass one, or mixtures or combinations of more than one hydrophobic liquid, polymer, and the like, unless otherwise specified.

Various numerical ranges may be disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Moreover, all numerical end points of ranges disclosed herein are approximate. As a representative example, Applicant discloses, in some embodiments, that the monomer comprising the sulfonic acid moiety or the sulfonate moiety is present in the polymer at a mol % of about 20 to about 30. This range should be interpreted as encompassing a mol % of about 20 and about 30, and further encompasses each of 21 mol %, 22 mol %, 23 mol %, 24 mol %, 25 mol %, 26 mol %, 27 mol %, 28 mol %, and 29 mol %, including any ranges and sub-ranges between any of these values.

As used herein, the term “about” means plus or minus 10% of the numerical value of the number with which it is being used.

### EMBODIMENTS

The following is a non-limiting listing of embodiments of the disclosure.

Embodiment 1. A method of treating a polymer-containing composition, the method comprising, consisting essentially of, or consisting of (i) providing a composition, the composition comprising a polymer, a hydrophobic liquid, a surfactant, and water, wherein the hydrophobic liquid is present in the composition at a first concentration; and (ii) contacting the composition and a sulfosuccinate ester salt to form a mixture, the mixture comprising a liquid phase and a solid phase, wherein the hydrophobic liquid is present in the liquid phase at a second concentration.

Embodiment 2. The method of Embodiment 1, further comprising heating the mixture to a temperature of at least 40° C., at least 50° C., at least 55° C., or at least 60° C. for at least 1 minute, at least 30 minutes, at least one hour, or at least two hours.

Embodiment 3. The method of Embodiment 1 or 2, further comprising applying one or more forces to the mixture, wherein the one or more forces are effective to facilitate and/or increase a rate of separation of the liquid phase and the solid phase.

Embodiment 4. The method of Embodiment 3, wherein the one or more forces comprises a centrifugal force, a gravitational force, stirring, shaking, sonication, or a combination thereof.

Embodiment 5. The method of any of the preceding embodiments, further comprising separating the liquid phase and the solid phase, such as by decanting, filtration, etc.

Embodiment 6. The method of any of the preceding embodiments, wherein the liquid phase has a viscosity of at least 3 cP, or at least 3.5 cP, or about 3 cP to about 4 cP, or about 3.5 cP at 7 s⁻¹ at 25° C.

First Concentration v. Second Concentration

Embodiment 7. The method of any of the preceding embodiments, wherein the second concentration is zero.

Embodiment 8. The method of any of the preceding embodiments, wherein the second concentration is about 20% to 100%, about 40% to 100%, about 60% to 100%, about 80% to 100%, or about 90% to 100% less than the first concentration (e.g., if the first concentration is 10 units and the second concentration is 2 units, then the second concentration is 80% less than the first concentration).

Embodiment 9. The method of any of the preceding embodiments, wherein the first concentration is about 1 ppm to about 15,000 ppm, about 1 ppm to about 10,000 ppm, about 1 ppm to about 5,000 ppm, about 1 ppm to about 3,000 ppm, about 1 ppm to about 2,000 ppm, about 1 ppm to about 1,000 ppm, about 100 ppm to about 1,000 ppm, or about 500 ppm to about 1,000 ppm of the composition.

### Sulfosuccinate Ester Salt

Embodiment 10. The method of any of the preceding embodiments, wherein the sulfosuccinate ester salt is present in the mixture at a concentration of about 0.01 wt % to about 10 wt %, about 0.01 wt % to about 8 wt %, about 0.01 wt % to about 6 wt %, about 1 wt % to about 5 wt %, or about 2 wt % to about 4 wt %, based on the weight of the composition (e.g., if 100 g of the composition and 1 g of the sulfosuccinate ester salt are present in the mixture, then the sulfosuccinate ester salt is present in the mixture at a concentration of 1 wt %, based on the weight of the composition).

Embodiment 11. The method of any of the preceding embodiments, wherein the sulfosuccinate ester salt is a sodium sulfosuccinate ester.

Embodiment 12. The method of any of the preceding embodiments, wherein the sulfosuccinate ester salt is a sulfosuccinate monoester salt, a sulfosuccinate diester salt, or a combination thereof.

Embodiment 13. The method of any of the preceding embodiments, wherein the sulfosuccinate ester salt is of formula (I)—

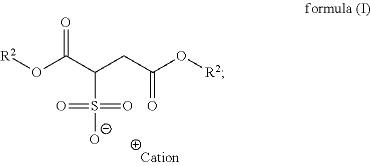

wherein R¹ and R² are independently selected from the group consisting of hydrogen and a C₁-C₃₀ hydrocarbyl.

Embodiment 14. The method of any of the preceding embodiments, wherein R¹ and R² are independently selected from the group consisting of hydrogen and a C₁-C₂₄ hydrocarbyl.

Embodiment 15. The method of any of the preceding embodiments, wherein R¹ and R² are independently selected from the group consisting of hydrogen and a C₆-C₁₈ hydrocarbyl.

Embodiment 16. The method of any of the preceding embodiments, wherein the cation is sodium.

Embodiment 17. The method of any of the preceding embodiments, wherein R¹ is hydrogen, and R² is the C₁-C₃₀ hydrocarbyl, the C₁-C₂₄ hydrocarbyl, or the C₆-C₁₈ hydrocarbyl.

Embodiment 18. The method of any of the preceding embodiments, wherein R¹ is the C₁-C₃₀ hydrocarbyl, the C₁-C₂₄ hydrocarbyl, or the C₆-C₁₈ hydrocarbyl, and R² is hydrogen.

Embodiment 19. The method of any of the preceding embodiments, wherein R¹ and R² are independently selected from the group consisting of hydrogen, octyl, 2-ethylhexyl, hexyl, and cyclohexyl.

Embodiment 20. The method of any of the preceding embodiments, wherein the sulfosuccinate ester salt is dioctyl sulfosuccinate sodium salt (e.g., bis(2-ethylhexyl) sulfosuccinate sodium salt).

### Polymer

Embodiment 21. The method of any of the preceding embodiments, wherein the polymer is present in the composition at a concentration of about 50 ppm to about 15,000 ppm, about 50 ppm to about 10,000 ppm, about 50 ppm to about 5,000 ppm, about 50 ppm to about 3,000 ppm, about 50 ppm to about 2,000 ppm, about 50 ppm to about 1,000 ppm, about 100 ppm to about 1,000 ppm, or about 500 ppm to about 1,000 ppm.

Embodiment 22. The method of any of the preceding embodiments, wherein the polymer comprises a homopolymer or a copolymer.

Embodiment 23. The method of any of the preceding embodiments, wherein the polymer comprises, consists essentially of, or consists of (i) an acrylamide monomer, (ii) a monomer comprising a sulfonic acid moiety or a sulfonate moiety, or (iii) a combination thereof.

Embodiment 24. The method of any of the preceding embodiments, wherein the monomer comprising the sulfonic acid moiety or the sulfonate moiety comprises acrylamide tertiary butyl sulfonic acid (ATBS).

Embodiment 25. The method of any of the preceding embodiments, wherein the monomer comprising the sulfonic acid moiety or the sulfonate moiety comprises, consists essentially of, or consists of vinylsulfonic acid, allylsulfonic acid, 2-acrylamido-2-methylpropanesulfonic acid, 2-methacrylamido-2-methylpropanesulfonic acid, 2-acrylamidobutanesulfonic acid, 3-acrylamido-3-methylbutanesulfonic acid, 2-acrylamido-2,4,4-trimethylpentanesulfonic acid, or a combination thereof.

Embodiment 26. The method of any of the preceding embodiments, wherein the acrylamide monomer is present in the polymer at a mol % of about 50 to 100, about 60 to about 90, about 60 to about 80, about 70 to about 80, or about 75.

Embodiment 27. The method of any of the preceding embodiments, wherein the monomer comprising the sulfonic acid moiety or the sulfonate moiety is present in the polymer at a mol % of about 1 to about 50, about 10 to about 40, about 10 to about 30, about 20 to about 30, or about 25.

Embodiment 28. The method of any of the preceding embodiments, wherein the polymer comprises, further comprises, consists essentially of, or consists of one or more monomers selected from the group consisting of acrylic acid, methacrylic acid, crotonic acid, itaconic acid, maleic acid, fumaric acid, monomers comprising phosphonic acid groups, vinylphosphonic acid, allylphosphonic acid, N-(meth)acrylamidoalkylphosphonic acids, (meth)acryloyloxyalkylphosphonic acids, hydroxyethyl(meth)acrylate, hydroxypropyl(meth)acrylate, allyl alcohol, hydroxyvinyl ethyl ether, hydroxyl vinyl propyl ether, hydroxyvinyl butyl ether or polyethyleneoxide(meth)acrylates, monomers having ammonium groups, 3-trimethylammonium propylacrylamides, 2-trimethylammonium ethyl(meth)acrylates, 3-trimethylammonium propylacrylamide chloride (DIMAPAQUAT), 2-trimethylammonium ethyl methacrylate chloride (MADAME-QUAT), monomers which may cause hydrophobic association of the (co)polymers, N-alkyl acrylamides, N-alkyl quaternary acrylamides, salts of the foregoing or and mixtures or combinations of the foregoing.

Embodiment 29. The method of any of the preceding embodiments, wherein the polymer is in form of particles.

Embodiment 30. The method of Embodiment 29, wherein the particles of the polymer have an average particle size of about 0.05 μm to about 30 μm, about 3 μm to about 18 μm, about 0.4 μm to about 5 μm, or about 0.5 μm to about 4 μm, or about 0.5 μm to about 2 μm; wherein the phrase “average particle size” refers to the d50 value of the particle size distribution (number average).

Embodiment 31. The method of any of the preceding embodiments, wherein the polymer has a weight average molecular weight (M_{w}) of greater than about 5,000,000 Dalton, or greater than about 10,000,000 Dalton, or greater than about 15,000,000 Dalton, or greater than about 20,000,000 Dalton; or greater than about 25,000,000 Dalton.

### Hydrophobic Liquid

Embodiment 32. The method of any of the preceding embodiments, wherein the hydrophobic liquid comprises, consists essentially of, or consists of an organic hydrophobic liquid.

Embodiment 33. The method of any of the preceding embodiments, wherein the hydrophobic liquid has a boiling point of at least 100° C., at least 135° C., or at least 180° C. (if the hydrophobic liquid has a boiling range, the phrase “boiling point” refers to the lower limit of the boiling range).

Embodiment 34. The method of any of the preceding embodiments, wherein the hydrophobic liquid comprises an aliphatic hydrocarbon, an aromatic hydrocarbon (e.g., toluene, xylene, etc.), or a combination thereof.

Embodiment 35. The method of any of the preceding embodiments, wherein the hydrophobic liquid comprises, consists essentially of, or consists of a paraffin hydrocarbon (e.g., saturated, linear, or branched), a naphthenic hydrocarbon, an olefin, an oil (e.g., a vegetable oil, such as soybean oil, rapeseed oil, canola oil, etc., and any other oil produced from the seed of any of several varieties of the rapeseed plant), a stabilizing surfactant, or a combination thereof.

### Surfactant

Embodiment 36. The method of any of the preceding embodiments, wherein the surfactant is present in the composition at a total concentration of about 1 ppm to about 1,000 ppm, about 1 ppm to about 800 ppm, about 1 ppm to about 700 ppm, about 1 ppm to about 600 ppm, about 1 ppm to about 500 ppm, about 1 ppm to about 400 ppm, about 1 ppm to about 300 ppm, or about 1 ppm to about 200 ppm; wherein the phrase “total concentration” refers to the concentration of all surfactants that are present in a composition, e.g., if there are two different surfactants present in the composition, such as a first surfactant and a second surfactant, the “total concentration” is the sum of the concentration of the first surfactant and the concentration of the second surfactant.

Embodiment 37. The method of any of the preceding embodiments, wherein the surfactant comprises an emulsifier surfactant, an inverting surfactant, or a combination thereof.

Embodiment 38. The method of Embodiment 37, wherein the emulsifier surfactant is selected from the group consisting of a sorbitan ester, an ethoxylated fatty alcohol with 1 to 4 ethyleneoxy groups, a phthalic ester, a fatty acid glyceride, a glycerine ester, a sorbitan monooleate, the reaction product of oleic acid and isopropanolamide, hexadecyl sodium phthalate, decyl sodium phthalate, sorbitan stearate, ricinoleic acid, hydrogenated ricinoleic acid, glyceride monoester of lauric acid, glyceride monoester of stearic acid, glycerol diester of oleic acid, glycerol triester of 12-hydroxystearic acid, glycerol triester of ricinoleic acid, an ethoxylated version of the foregoing comprising 1 to 10 moles of ethylene oxide per mole of the basic emulsifier, a modified polyester surfactant, an anhydride substituted ethylene copolymer, an N,N-dialkanol substituted fatty amide, a tallow amine ethoxylate, and a combination thereof.

Embodiment 39. The method of Embodiment 37, wherein the inverting surfactant is selected from the group consisting of an ethoxylated alcohol, an alcohol ethoxylate, an ethoxylated ester of sorbitan, an ethoxylated ester of a fatty acid, an ethoxylated fatty acid ester, an ethoxylated ester of sorbitol and/or a fatty acid, a nonionic surfactant comprising a hydrocarbon group and a polyalkylenoxy group of sufficient hydrophilic nature, a nonionic surfactant of the general formula Rₐ—O—(CH(Re)—CH₂—O)ₙH, wherein Rₐ is a C₈-C₂₂-hydrocarbon group, n is a number of ≥4, and R_{b} is H, methyl or ethyl, and at least 50% of the groups R_{b} are H, a polyethoxylate based on a C₁₀-C₁₈-alcohol, a tridecylalcohol ethoxylate comprising 4 to 14 ethylenoxy groups, a modified polyester surfactant, an anhydride substituted ethylene copolymer, an N,N-dialkanol substituted fatty amide, a tallow amine ethoxylate, and a combination thereof.

### Water

Embodiment 40. The method of any of the preceding embodiments, wherein the water is present in the composition at an amount of at least 90 wt %, at least 95 wt %, or at least 98%, based on the weight of the composition.

Embodiment 41. The method of any of the preceding embodiments, wherein the water comprises, consists essentially of, or consists of produced water, fresh water, salt water (e.g., sea water), or a combination thereof.

Embodiment 42. The method of Embodiment 40, wherein the salt water comprises a brine, such as a naturally-occurring brine.

Embodiment 43. The method of Embodiment 42, wherein the brine is a chloride-based, bromide-based, formate-based, or acetate-based brine comprising monovalent cations, polyvalent cations, or a combination thereof.

Embodiment 44. The method of any of the preceding embodiments, wherein the water comprises about 15,000 mg/L to about 300,000 mg/L, about 15,000 mg/L to about 250,000 mg/L, about 15,000 mg/L to about 200,000 mg/L, about 15,000 mg/L to about 160,000 mg/L, about 15,000 mg/L to about 100,000 mg/L, about 15,000 mg/L to about 50,000 mg/L, about 30,000 mg/L to about 40,000 mg/L, or about 15,000 mg/L to about 16,000 mg/L total dissolved solids (tds).

### Methods of Polymer Flooding/Enhanced Oil Recovery

Embodiment 45. A method of polymer flooding, the method comprising (i) providing the liquid phase of any of the preceding embodiments; and (ii) injecting the liquid phase into a mineral oil deposit.

Embodiment 46. The method of Embodiment 45, wherein the liquid phase is injected at a rate of about 5 feet/day to about 20 feet/day, or about 10 feet/day to about 15 feet/day.

Embodiment 47. The method of Embodiment 45 or 46, wherein the mineral oil deposit comprises rock having a permeability of about 50 mD (millidarcy) to about 2,000 mD, about 50 mD to about 1,500 mD, about 50 mD to about 1,000 mD, about 50 mD to about 750 mD, about 50 mD to about 500 mD, or about 50 mD to about 300 mD.

Embodiment 48. The method of any of the preceding embodiments, wherein a differential pressure stabilizes (i) after the injecting of about 1.5 pore volumes or about 2 pore volumes of the liquid phase, and (ii) before the injecting of about 3 pore volumes or about 3.5 pore volumes; a differential pressure “stabilizes” when the differential pressure reaches a value from which the differential pressure does not deviate by more than +/−20%, +/−15%, or +/−10% during the injection of at least 5, at least 6, at least 7, or at least 8 additional pore volumes of the liquid phase into the mineral oil deposit.

Embodiment 49. The method of any of the preceding embodiments, wherein a resistance factor (RF) of the polymer flooding (i) after the injecting of about 1.5 pore volumes or about 2 pore volumes of the liquid phase, and (ii) before the injecting of about 3 pore volumes or about 3.5 pore volumes is within about 10% of (a) a theoretical resistance factor, or (b) a measured resistance factor of a comparative composition that does not include the hydrophobic liquid.

### Inverting of Emulsion

Embodiment 50. The method of any of the preceding embodiments, wherein the providing of the composition comprises, consists essentially of, or consists of (i) providing an emulsion (e.g., a water-in-oil emulsion) comprising the polymer, the hydrophobic liquid, and the surfactant, wherein water (e.g., first type of water) is present in the emulsion at a concentration of less than 25 wt %, less than 15 wt %, less than 12 wt %, or less than 10 wt %, based on the weight of the emulsion; and (ii) contacting the emulsion and an additional amount of water (e.g., second type of water) to form the composition of any of the preceding embodiments; wherein the additional amount of water optionally comprises at least a portion of the sulfosuccinate ester salt, thereby providing the composition and contacting the composition and the sulfosuccinate ester salt at least partially simultaneously.

Embodiment 51. The method of Embodiment 50, wherein the emulsion, prior to the contacting of the emulsion and the additional amount of water, comprises at least about 20 wt %, about 25 wt %, about 30 wt %, about 35 wt %, about 39 wt %, about 40 wt %, about 45 wt %, about 50 wt %, about 55 wt %, about 60 wt %, about 65 wt %, about 70 wt %, or about 75 wt % of the polymer, based on the weight of the emulsion.

### Liquid Phase

Embodiment 52. A liquid phase of any of the preceding embodiments.

Embodiment 53. A liquid phase formed by any of the methods of the preceding embodiments.

### EXAMPLES

### Example 1—Removal of Oil from Polymer-Containing Liquid

In this example, a sulfonated polymer-containing liquid was used, which included a breaker at an amount of about 6 wt %. The polymer of this example was a copolymer formed of about 75 mol % acrylamide (AM) and about 25 mol % acrylamido tertiary butyl sulfonate (ATBS).

A mother solution (350 g) was prepared that included 10,000 ppm of the copolymer in brine. The mother solution was prepared with an overhead stirrer (500 rpm, 2 hours) in a beaker. The mother solution was then diluted to include 750 ppm of the copolymer using the overhead stirrer (500 rpm, 2 hours), and the resulting liquid had a cloudy, milky appearance.

An amount (15 g) of the liquid containing 750 ppm of the copolymer was weighed at room temperature in a 50 mL centrifuge tube, and then 0.15 g (i.e., 1 wt % based on the liquid) of dioctyl sulfosuccinate sodium salt (96% pure solid) was added to the centrifuge tube. The mixture was then placed on a reciprocal shaker for 20 minutes. Upon completion of the mixing, the sample tube was transferred to an oven at 55° C. for two hours. The sample was then cooled to room temperature, and transferred to a centrifuge for 20 minutes at 9,000 rpm.

The sample, upon completion of the foregoing steps, was clear, and included a white precipitate at the bottom of the tube. The top liquid was collected by decanting or syringe.

A 15 g sample of the liquid was kept as an untreated control sample.

### Example 2—Removal of Oil from Polymer-Containing Liquid

The procedure of Example 1 was repeated, except 0.3 g (i.e., 2 wt % based on the liquid) dioctyl sulfosuccinate sodium salt was added to the centrifuge tube.

### Example 3—Removal of Oil from Polymer-Containing Liquid

The procedure of Example 1 was repeated, except 0.45 g (i.e., 3 wt % based on the liquid) dioctyl sulfosuccinate sodium salt was added to the centrifuge tube.

### Example 4—Removal of Oil from Polymer-Containing Liquid

The procedure of Example 1 was repeated, except 0.6 g (i.e., 4 wt % based on the liquid) dioctyl sulfosuccinate sodium salt was added to the centrifuge tube.

A photograph was taken of the untreated control sample and the samples of Examples 1-4. The samples of Examples 1-4 were clear, whereas the untreated control sample had a cloudy, milky appearance.

### Example 5—Removal of Oil from Polymer-Containing Liquid

An inverted liquid was prepared in the manner described in Example 1, and 180 g of the liquid was disposed in a glass jar. Then, 1.8 g of dioctyl sulfosuccinate sodium salt was added to the glass jar. The resulting mixture was stirred with an overhead propeller type stirrer at 200 rpm for half an hour. The mixture then was placed in an oven at 55° C. for 1.5 hours. Upon cooling, the mixture was centrifuged at 9,000 rpm for 20 minutes. The top liquid was then collected.

The viscosities of the liquids—pre- and post-treatment—were measured with an ANTON PAAR® MCR 102 rheometer using a DG26.7 double gap fixture at 25° C. A slight change in the viscosities was observed between the treated solution (3.25 cP) and untreated solution (3.76 cP) at 6.21 s⁻¹.

### Example 6—Injection of Treated Polymer-Containing Liquids

A polymer-containing liquid was prepared by the procedure of Example 1, and treated by the procedure of Example 5. The treated liquid was injected at 15 feet/day into a 130 mD Berea core (1.5 inches in diameter, 3 inches in length). The differential pressure was stabilized at about 3 psi within 2 PV (pore volumes), and the corresponding RF (resistant factor) of polymer flooding was about 3.4.

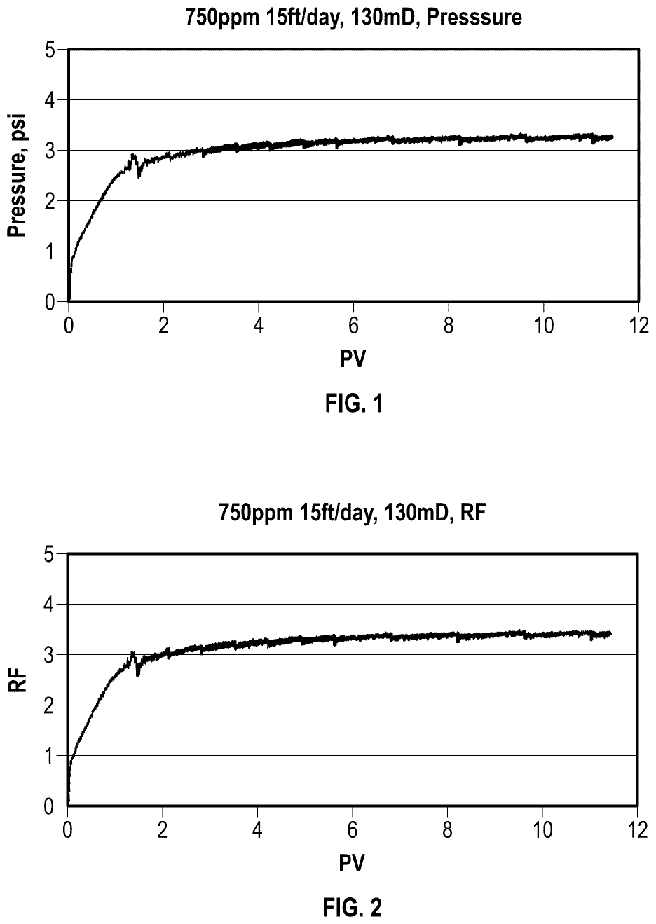

FIG. 1 depicts a plot of pressure (psi) versus PV, and FIG. 2 depicts a plot of RF versus PV for the tests of this example. Both the injected and effluent liquids were 3.5 cP at 7 s⁻¹ at 25° C.

### Example 7—Injection of Treated Polymer-Containing Liquid

The treated inverted emulsion of Example 6 was injected at 15 feet/day for 10 PV, and at 10 feet/day for another 5 PV in a new Berea core (120 mD, 1.5 inches in diameter, and 6 inches in length). The differential pressure during polymer flooding was stabilized within about 2 to about 3 PV, and the corresponding RFs of polymer floodings at both injection rates were 6 and 5.5.

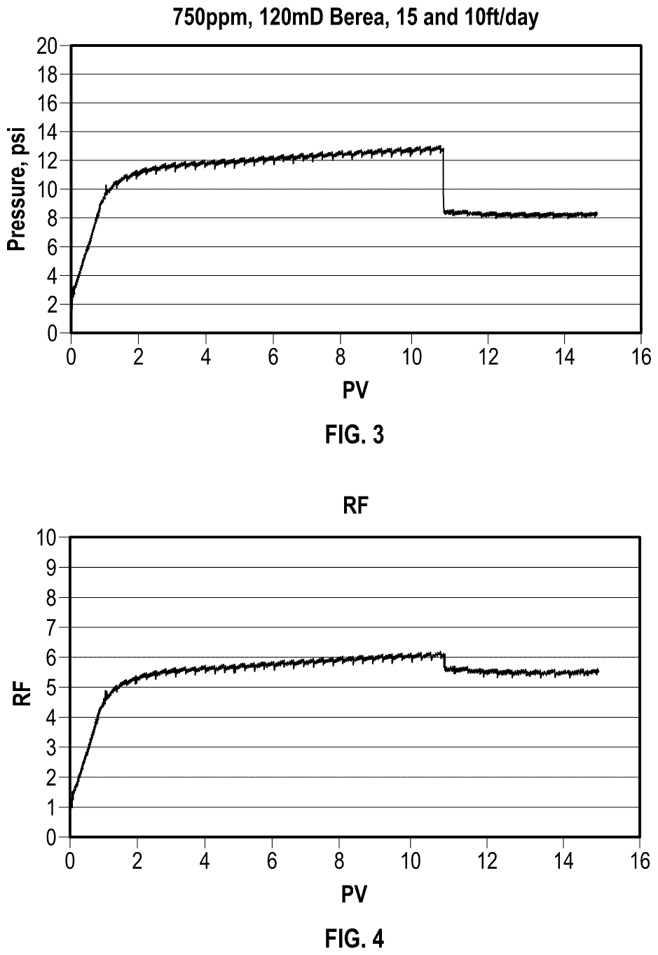

FIG. 3 depicts a plot of pressure (psi) versus PV, and FIG. 4 depicts a plot of RF versus PV for the tests of this example. Both the injected and effluent solutions were 3.5 cP at 7 s⁻¹ at 25° C. The RFs were slightly higher than theoretical values. The theoretical values were based on an assumption of complete oil removal.

### Example 8—Comparative Example

For comparison purposes, an untreated liquid directly diluted from the 10,000 ppm mother solution of Example 1 was injected at 15 feet/day and 10 feet/day into a new Berea core (65 mD, 1.5 inches in diameter, and 6 inches in length). A stable differential pressure was not reached in the first polymer injection at 15 feet/day. The differential pressure was flat when the injection rate was reduced to 10 feet/day, and the stabilized pressure (about 78 psi) was significantly greater than the theoretical stabilized pressure.

The following table shows the viscosities (cP at 7 s⁻¹ at 25° C.) collected during the testing of this example.

| | Inlet | Outlet |
|---|---|---|
| First Injection | 3.94 | — |
| First Injection, Day 2 | 4.12 | 4.8 |
| Second Injection | 3.98 | — |
| Second Injection, Day 2 | 4.22 | 4.7 |

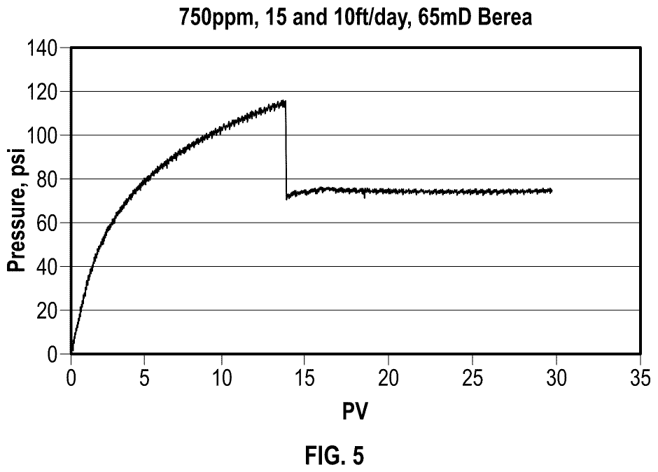

FIG. 5 depicts a plot pressure versus PV for the first injection of the comparative liquid of this Example.

1. A method of treating a polymer-containing liquid, the method comprising:
providing a composition, the composition comprising a polymer, a hydrophobic liquid, a surfactant, and water, wherein the hydrophobic liquid is present in the composition at a first concentration, wherein the first concentration is about 1 ppm to about 15,000 ppm; and
contacting the composition and a sulfosuccinate ester salt to form a mixture, the mixture comprising a liquid phase and a solid phase, wherein the hydrophobic liquid is present in the liquid phase at a second concentration, wherein the second concentration is about 80% to 100% less than the first concentration;
wherein the hydrophobic liquid has a boiling point of at least 100° C.;
wherein the polymer is present in the composition at a concentration of about 50 ppm to about 15,000 ppm;
wherein the polymer is a copolymer comprising an acrylamide monomer and a monomer comprising a sulfonic acid moiety or a sulfonate moiety; and
wherein the sulfosuccinate ester salt is present in the mixture at a concentration of about 0.01 wt % to about 10 wt %, based on the weight of the composition.

2. The method of claim 1, further comprising (i) heating the mixture to a temperature of at least 40° C. for at least one hour, (ii) applying one or more forces to the mixture, wherein the one or more forces are effective to facilitate separation of the liquid phase and the solid phase, or increase a rate of separation of the liquid phase and the solid phase, or (iii) a combination thereof.

3. The method of claim 1, wherein the sulfosuccinate ester salt is present in the mixture at a concentration of about 0.01 wt % to about 5 wt %, based on the weight of the composition.

4. The method of claim 1, wherein the sulfosuccinate ester salt is of formula (I)— 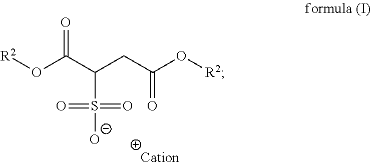
wherein R¹ and R² are independently selected from the group consisting of hydrogen and a C₁-C₃₀ hydrocarbyl.

5. The method of claim 4, wherein R¹ and R² are independently selected from the group consisting of hydrogen and a C₆-C₁₈ hydrocarbyl.

6. The method of claim 4, wherein the cation is sodium.

7. The method of claim 4, wherein R¹ is hydrogen, and R² is the C₁-C₃₀ hydrocarbyl; or wherein R¹ is the C₁-C₃₀ hydrocarbyl, and R² is hydrogen.

8. The method of claim 4, wherein R¹ and R² are independently selected from the group consisting of hydrogen, octyl, 2-ethylhexyl, hexyl, and cyclohexyl.

9. The method of claim 1, wherein the sulfosuccinate ester salt is dioctyl sulfosuccinate sodium salt.

10. The method of claim 1, wherein (i) the surfactant is present in the composition at a total concentration of about 1 ppm to about 1,000 ppm, and (ii) the surfactant comprises an emulsifier surfactant, an inverting surfactant, or a combination thereof.

11. The method of claim 1, wherein the providing of the composition comprises:
providing a water-in-oil emulsion comprising the polymer, the hydrophobic liquid, and the surfactant, wherein water is present in the water-in-oil emulsion at a concentration of less than 25 wt %, based on the weight of the water-in-oil emulsion; and
contacting the water-in-oil emulsion and an additional amount of water to form the composition;
wherein the additional amount of water optionally comprises at least a portion of the sulfosuccinate ester salt.

12. The method of claim 11, wherein the additional amount of water comprises produced water, fresh water, salt water, or a combination thereof.

13. A method of polymer flooding, the method comprising:
providing the liquid phase of claim 1; and
injecting the liquid phase into a mineral oil deposit, wherein the mineral oil deposit comprises rock having a permeability of about 50 mD (millidarcy) to about 2,000 mD.

14. The method of claim 13, wherein a differential pressure stabilizes (i) after the injecting of about 1.5 pore volumes of the liquid phase, and (ii) before the injecting of about 3.5 pore volumes.

15. The method of claim 13, wherein a resistance factor (RF) of the polymer flooding (i) after the injecting of about 1.5 pore volumes, and (ii) before the injecting of about 3.5 pore volumes is within about 10% of (a) a theoretical resistance factor, or (b) a measured resistance factor of a comparative composition that does not include the hydrophobic liquid.
